(19) United States
(12) Patent Application Publication
(10) Pub. No.: US 2022/0058367 A1
(43) Pub. Date: Feb. 24, 2022

(54) METHOD FOR AUTOMATICALLY SEARCHING FOR THICKNESS PARAMETERS OF DISPLAY SCREEN, STORAGE MEDIUM AND ELECTRONIC DEVICE

(71) Applicant: SHANGHAI HARVEST INTELLIGENCE TECHNOLOGY CO., LTD., Shanghai (CN)

(72) Inventor: Zongwen CHEN, Shanghai (CN)

(73) Assignee: SHANGHAI HARVEST INTELLIGENCE TECHNOLOGY CO., LTD., Shanghai (CN)

(21) Appl. No.: 17/275,376

(22) PCT Filed: Jul. 3, 2019
(86) PCT No.: PCT/CN2019/094570

§ 371 Date: Mar. 11, 2021

(30) Foreign Application Priority Data
Sep. 12, 2018 (CN) 201811062622.1

(51) Int. Cl. G06K 9/00; G09G 3/3225; G09G 3/34

(52) U.S. Cl. CPC G06K 9/00046; G09G 3/3406; G09G 3/3225; G06K 9/0004

(57) ABSTRACT

The present invention is related to a technical field of optical fingerprint, especially related to a method for automatically search for thickness parameters of a display screen, a storage medium and an electronic device. The method for automatically search for thickness parameters of a display screen includes the following steps: processing a fingerprint image to decide a circular dark region corresponding to any point light source, wherein the circular dark region has a diameter of D, and calculating a screen thickness parameter based on a value of D. Effectively using information of lens-free imaging to calculate the screen thickness parameter in real time facilitates subsequent data processing.

### TECHNICAL FIELD

The present invention is related to a technical field of optical fingerprint, especially related to a method for automatically search for a display screen thickness parameter, a storage medium and an electronic device.

### BACKGROUND ART

As information technology develops, biometric identification technology plays a more and more important role in an aspect of ensuring information security, wherein fingerprint recognition has become one of the key technical means for identity identification and device-unlocking that are widely applied in the field of mobile networking. Under the trend that the screen-to-body ratios of appliances get larger and larger, conventional capacitive fingerprint recognition has failed to meet the requirements, and ultrasonic fingerprint recognition has problems in aspects of technology maturity, cost, etc. Optical fingerprint recognition is expected to become a major technical scheme of under-screen fingerprint recognition.

An existing optical fingerprint recognition scheme is based on principles of geometric optical lens imaging, using fingerprint modules including devices such as a microlens array and an optical spatial filter, and having many drawbacks such as having complex structure, thick module, small sensing range and high cost. In comparison to the existing optical fingerprint scheme, implementing lens-free under-screen optical fingerprint recognition through principles of total reflection imaging of physical optics has advantages such as having simple structure, thin module, large sensing range and low cost. However, data processing of lens-free under-screen optical fingerprint imaging with structural light illumination relies heavily on the thickness parameter of the display screen, and the parameter causes great uncertainty because of in the different types of screen protector films added by users, thereby bringing about a technical obstacle against widespread application of lens-free under-screen optical fingerprint recognition technique.

### CONTENT OF INVENTION

Therefore, providing a method for automatically searching for thickness parameters of a display screen is needed, in order to solve the problem that in optical fingerprint recognition, the thickness parameter of the display screen cannot be obtained in real-time. A specific technical scheme is described below:

A method for automatically searching for thickness parameters of a display screen includes steps of: processing a fingerprint image to decide a circular dark region corresponding to any point light source, the circular dark region having a diameter of D; and calculating a screen thickness parameter based on a value of D.

Furthermore, the “processing a fingerprint image to decide a circular dark region corresponding to any point light source” further includes steps of: deciding a position of a bright spot corresponding to a point light source in the fingerprint image, and performing gradual and outward scan with the bright spot as a center of a circle, an edge where a scanned average grayscale value just meets a maximum.

Furthermore, the “processing a fingerprint image to decide a circular dark so region corresponding to any point light source” further includes a step of: scanning the fingerprint image to encircle a region where grayscale values are below a predetermined threshold, an outmost edge of the region being regarded as the circumference of the circular dark region.

Furthermore, before the “processing a fingerprint image”, steps are further included: lighting up pixel points of multiple separate point light source regions of a display panel, wherein the point light source regions are arranged in an array and are spaced by nonluminous pixel points, and the point light source regions include multiple pixel points; obtaining, through a light sensor, light of a pixel point that is totally reflected through a light transmissible cover plate; wherein the display panel and the light sensor are placed under the light transmissible cover plate.

Furthermore, the array arrangement is lateral arrangement and longitudinal arrangement, or the array arrangement is ring arrangement.

Furthermore, an interval between two adjacent point light sources meets a condition that point light source total reflection images that are collected by the light sensor do not contact and do not repeat.

Furthermore, the display panel is a liquid-crystal display, an active-matrix organic light-emitting diode display or a micro light-emitting diode display.

Furthermore, the point light source region has a round-like shape.

In order to solve the above-mentioned problem, a storage medium is also provided. A specific technical scheme is as follows:

A storage medium. The storage medium stores a computer program, wherein the computer program when executed by a processor performs any step of the above-mentioned method thus described.

In order to solve the above-mentioned problem, an electronic device is also provided. A specific technical scheme is as follows:

An electronic device includes storage and a processor, wherein a computer program is stored in the storage, and the computer program when executed by the processor performs any step of the above-mentioned method thus described.

A beneficial effect of the present invention lies in: effectively using so information of lens-free imaging to calculate the screen thickness parameter in real time, thereby facilitating subsequent data processing.

### DESCRIPTION OF ACCOMPANYING FIGURES

FIG. 1 is a schematic diagram for lens-free under-screen optical fingerprint imaging implemented by using principles of total reflection imaging;

FIG. 2 is a schematic diagram for lens-free under-screen optical fingerprint imaging implemented by using principles of total reflection imaging;

FIG. 3 is a schematic diagram for principles of forming a circular dark region;

FIG. 4 is a flow chart of a method for automatically searching for thickness parameters of a display screen;

FIG. 5 is a schematic diagram for generating a fuzzy image;

FIG. 6 is a schematic diagram of an array of multiple separate point light source regions of a display panel;

FIG. 7 is a distribution graph of pixel points included in a point light source of an embodiment;

FIG. 8 is a block diagram of a storage medium;

FIG. 9 is a block diagram of an electronic device.

### DESCRIPTION OF SYMBOLS OF THE ACCOMPANYING FIGURES

800 storage medium,
900 electronic device,
901 storage,
902 processor.

### Specific Implementation Manner

In order to describe the technical content, structural features, achieved goals and effects of the technical scheme(s) in detail, the following provides detailed description in combination with specific embodiments and the accompanying figures.

Please refer to FIG. 1 through FIG. 7, this embodiment provides a method for automatically searching for thickness parameters of a display screen. The method is applied on an electronic device. The electronic device includes but is not limited to: a personal computer, a server, a general purpose computer, a special purpose computer, a network device, an embedded device, a programmable device, a smart mobile terminal, a smart home appliance, a wearable smart device, a vehicle smart device, etc.

It needs to be made clear that in this embodiment, a fingerprint image to be processed is obtained by a particular under-screen-image imaging structure. As shown in FIG. 1, the under-screen-image imaging structure includes a light transmissible cover plate, a light source plate and a light sensor. The light source plate and the light sensor are positioned under the light transmissible cover plate, wherein, the light transmissible cover plate may be a single-layer structure or a multi-layer structure. The single-layer structure may be a glass cover plate or a cover plate of an organic light transmissible material. The single-layer structure may also be a cover plate that has other function(s), for example, a touch screen. The multi-layer structure may be multiple layers of glass cover plates or multiple layers of cover plates of organic light transmissible material(s), or a combination of a glass cover plate with a cover plate of an organic light transmissible material. The light sensor is used for obtaining light, includes multiple light-sensing units, and can be individually disposed under the light source plate or disposed on the light source plate. When being disposed under the light source plate, light can pass through gaps among light sources on the light source plate and enter the light sensor. When being disposed on the light source plate, the light-sensing units can be disposed in the light source gaps of the light source plate. The sensor may be disposed in the under-screen-image imaging structure for obtaining an under-screen image, for example, for obtaining fingerprints or palm prints. The light transmissible cover plate and the light source plate need to be connected by filling optical cement, in order to prevent reflection of the light from being affected by air. The refractive index of the optical cement should be close to the refractive index of the light transmissible cover plate, in order to prevent total reflection of the light from occurring between the optical cement and the light transmissible cover plate.

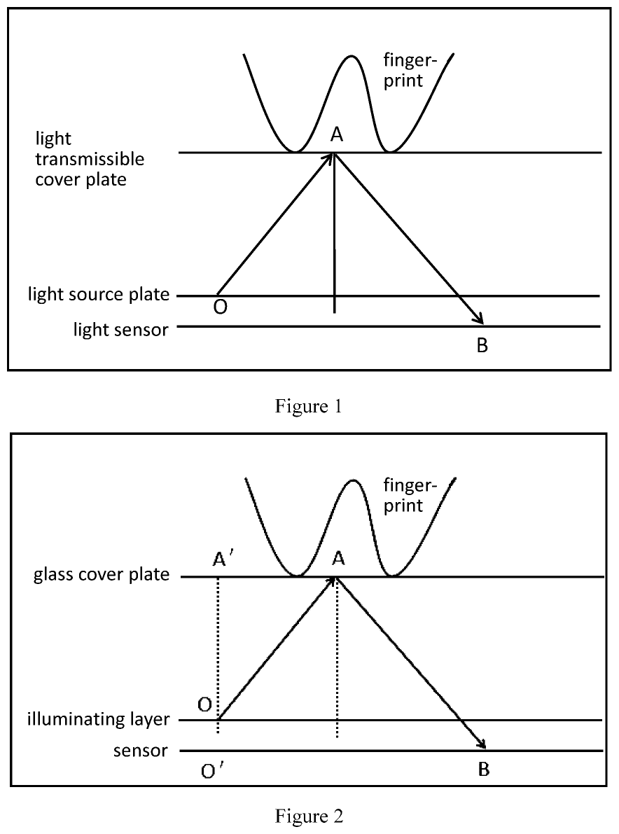

In this embodiment, as shown in FIG. 2, the light transmissible cover plate is exemplified by a glass cover plate. In that case, when a fingerprint is being obtained, a certain point A on the glass cover plate (cover glass) that is pressed by a finger is to be imaged onto a point B on a surface of the sensor. Based on conditions of the total reflection, the light emitted by a single illuminating point O on the light source plate is just sufficient to satisfy the needs.

In this embodiment, an interval between point light sources is set such that generated images do not overlap each other, i.e., the interval between two adjacent point light sources meets a condition that point light source total reflection images that are collected by the light sensor do not contact and do not repeat. Therefore, in this embodiment, the sensor forms a circular dark region around a point light source P. The circular dark region is not affected by other point light sources. There is a bright spot in the middle of the dark region. Outward from the bright spot, an average grayscale value of the dark region gradually increases. A plurality of such circular dark regions may be included in the fingerprint image to be processed but not affect one another. Specific principles for forming a dark region of a single point light source are as follows:

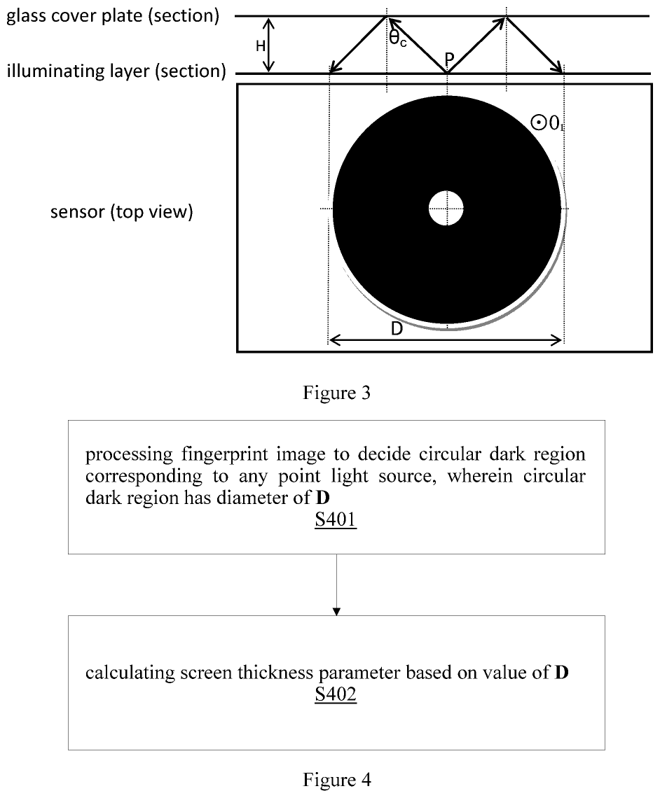

Referring to FIG. 3, in this embodiment, the core technical concept of the present invention is as follows.

As shown in FIG. 3, θ_{c} is a critical angle for the light emitted by the point light source P to be reflected on the glass cover plate. When the angle of incidence is less than θ_{c}, most of the light passes through the glass cover plate with refraction, so no clear reflected light can be detected by the sensor, and so on the sensor, a circular dark region around the point light source P is formed (a bright spot is formed at the center of the dark region because the light that lights up the point light source P is cast directly to the sensor). The outside diameter of the dark region is denoted by D, the thickness of the cover plate glass is denoted by H, and the thickness of the glass plate can be calculated based on a trigonometric function:

$$H = \frac{D}{4 tan θ}$$

In addition, the critical angle for total reflection is calculated as follows:

When light is cast from an optically denser medium to an optically thinner medium, the angle of refraction is larger than the angle of incidence. When the angle of incidence increases to a certain angle θ_{c} such that the angle of refraction reaches 90°, the refracted light disappears. When the angle of incidence is larger than θ_{c}, there is only reflected light, this phenomenon is called total reflection, and the corresponding angle of incidence θ_{c} is called the critical angle for total reflection.

When light travels to vacuum (having a refractive index of 1) from glass that has a refractive index of n, the law of refraction is

sin θᵢ=n×sin θₜ \textcircled{1}

wherein θᵢ and θₜ are the angle of incidence and the angle of refraction, respectively. When the angle of incidence θᵢ equals the critical angle θ_{c},

$$sin {θ}_{c} = \frac{1}{n}$$

is obtained by bringing the angle of refraction θₜ=90° into equation \textcircled{1}, and the critical angle is:

$${θ}_{c} = arcsin \frac{1}{n}$$

Therefore, as long as the diameter D of the circular dark region is known, the screen thickness parameter can be automatically calculated in real-time based on the value of D.

Please refer to FIG. 4. In this embodiment, a specific embodiment of a method for automatically search for thickness parameters of a display screen is as follows:

Step S401: processing the fingerprint image to decide a circular dark region corresponding to any point light source, wherein the circular dark region has a diameter of D.

In this embodiment, preferably, the “processing a fingerprint image to decide a circular dark region corresponding to any point light source” further includes steps of: deciding a position of a bright spot corresponding to a point light source in the fingerprint image, and performing gradual and outward scanning with the bright spot as a center of a circle, wherein an edge where a scanned average grayscale value just meets a maximum value is regarded as the circumference of the circular dark region. The manner described below may be utilized:

Scanning is performed on the obtained fingerprint image to decide a position of a bright spot corresponding to a point light source in the fingerprint image (the grayscale value of the position is far greater than grayscale values of a surrounding region). After completing confirmation, scanning that gradually goes outward in a circular shape with any bright spot as a center of the circle is performed, wherein the average grayscale value of the scanned region becomes larger and larger as the circular shape becomes larger. As shown in FIG. 3, when reaching a region where the point light source P is just totally reflected into the sensor plate, the average grayscale value of the scanned region just meets the maximum value, and the average grayscale values therebeyond equal the maximum value. Therefore, an edge of the circle where the maximum value is just met is regarded as the circumference of the circular dark region, and the diameter D of the circular dark region is derived.

Step S402: calculating a screen thickness parameter based on the value of D. Based on the above-mentioned technical conception, it can be deduced that:

$$H = \frac{D}{4 tan {θ}_{c}}$$

Effectively using information of lens-free imaging to calculate the screen thickness parameter in real time facilitates subsequent data processing.

In another embodiment, the “processing a fingerprint image to decide a circular dark region corresponding to any point light source” further includes a step of: scanning the fingerprint image to encircle a region where grayscale values are below a predetermined threshold, wherein an outmost edge of the region is regarded as the circumference of the circular dark region. The manner described below may be utilized: A threshold is predetermined, wherein the threshold corresponds to a magnitude of a grayscale value that corresponds to a point on the sensor panel where the point light source irradiates when total reflection just happens. Then, when the angle of incidence of the light source P is smaller than the critical angle, the grayscale value of the image portion, to which its light reflected to the sensor last corresponds, is less than the predetermined threshold. Then, by encircling a region where grayscale values are lower than the predetermined threshold, a circular dark region is encircled, and therefore the outer edge of a single region is regarded as the circumference of the circular dark region. Because the number of circular dark regions formed on the obtained fingerprint image varies with the number of point light sources, multiple circular dark regions may be encircled based on the method, and an outer edge of any region may simply be chosen therefrom to serve as the circumference of the circular dark region.

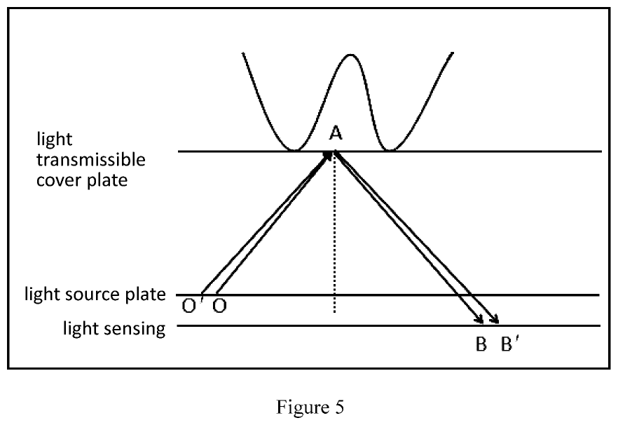

Please refer to FIG. 5. In reality, when there is another illuminating point O′ in the vicinity of point O, the point A on the glass cover plate will have two imaged points B and B′ on the sensor surface, thereby resulting in a fuzzy image. In order to ensure that a clear and usable fingerprint image may be obtained, in this embodiment, combining multiple pixel points is utilized to form a synthesized point light source having integral brightness that meets an imaging requirement. Meanwhile, the finger is lit up simultaneously through multiple separate point light sources, thereby satisfying a requirement of fast under-screen-image imaging. Specific steps are as follows:

Lighting up pixel points of multiple separate point light source regions of a display panel, wherein the point light source regions are arranged in an array and are spaced apart by nonluminous pixel points, and the point light source regions include multiple pixel points; obtaining, through a light sensor, light of a pixel point that is totally reflected through a light transmissible cover plate; wherein the display panel and the light sensor are placed under the light transmissible cover plate. In this embodiment, the multiple separate point light source regions may light up multiple regions on the light transmissible cover plate, and then the light that has been totally reflected by the light transmissible cover plate can be obtained by the light sensor. In this way, images of multiple regions can be obtained, and efficiency of obtaining images is increased. At the same time, the point light source regions include multiple pixel points, thereby satisfying the requirement for illumination brightness for imaging, so that collection of image(s) on the light transmissible cover plate can be realized. Usability of the collected fingerprint image is guaranteed.

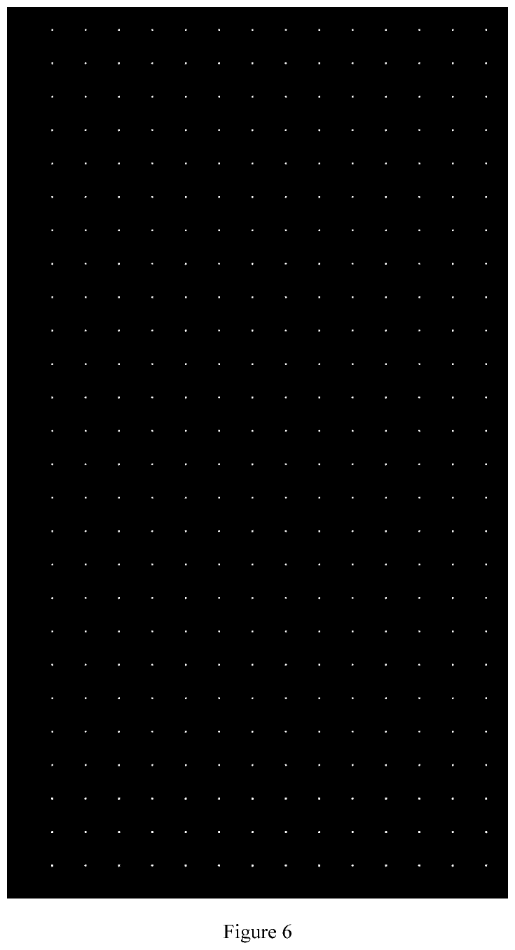

There are multiple ways of arrangement for the array arrangement of the point light sources of this embodiment, a preferable one among which is uniform arrangement where distances each between two adjacent point light sources are equal, so that the reflected image of every point light source is the same, which facilitates subsequent image processing. A specific way of the arrangement may be lateral arrangement and longitudinal arrangement, or the array arrangement may be ring arrangement. The lateral arrangement refers to multiple point light sources constituting multiple parallel lateral lines and multiple parallel longitudinal lines. As shown in FIG. 6 where the white points therein are the point light sources, the lateral lines and the longitudinal lines are preferably perpendicular to each other, but of course, a certain included angle (e.g., 60°, etc.) may appear in some embodiments. The ring arrangement may refer to point light sources positioned on circles with the center of the screen as a center of the circles and with gradually increasing radiuses.

The interval of the point light sources depends on imaging quality. In order to prevent overlap between imaging, the interval between two adjacent point light sources satisfies a condition that point light source total reflection images that are collected by the light sensor do not contact and do not repeat. Preferably, the interval of the point light sources may take a minimum value under the condition that total reflection images of two adjacent point light sources do not contact and do not repeat. This minimum value can be obtained through multiple times of manual testing by, for example, obtaining total reflection images of point light sources with different intervals of the point light sources, and then checking a minimum value of an interval of the point light sources in reflection image(s) satisfying the condition of no contact and no repeat. Afterwards, said minimum value can be preset in a storage device used to perform the present method. In reality, the interval of the point light sources may be affected by the interval between the light source and the cover plate, and these two intervals have a positive proportional relationship. In practical applications, screen hardware coefficients of a product usually do not change, so for these particular screens, adopting multiple manual testing for the attainment is more direct and convenient.

Just as described above, the present invention combines multiple pixel points to form a synthesized point light source having overall brightness that satisfies the imaging requirement. At the same time, the outer shape of the point light source also affects the imaging quality. The point light source is preferably to have a round-like shape. Because in practical, every pixel has a square shape, a combination of multiple pixels cannot form a standard round shape, and can only form a round-like shape that is close to a round shape. Determination of pixel points of a round-like shape can be made by drawing a circle with a certain pixel point serving as the center. The pixel points inside the circle can all be considered as the pixel points of the round-like shape. A predetermined ratio of area occupied by pixel points on the circumference can be set. When a ratio of the area inside the circle that is occupied by the circumference pixel points to the total area of the pixel points is larger than the predetermined ratio of area, the pixel points are considered as pixel points of the point light source for the round-like shape. The size of the circle determines light intensity of the point light source and whether the light sensor is able to obtain images with better quality. If the circle is too small, the point light source region would be too small, thereby producing insufficient light; if the circle is too big, the point light source region would be too small, thereby affecting imaging quality. Similarly, different display panels may have different light source intensities, so the size of the point light source region also varies from display panel to display panel. For a particular image-imaging-obtaining structure, the size of the point light source region can also be obtained by adopting multiple manual testing. The size of the point light source region can be lit up in a small-to-large order. Then, after the light sensor has obtained image data, a smallest point light source region with a satisfying imaging quality is manually selected.

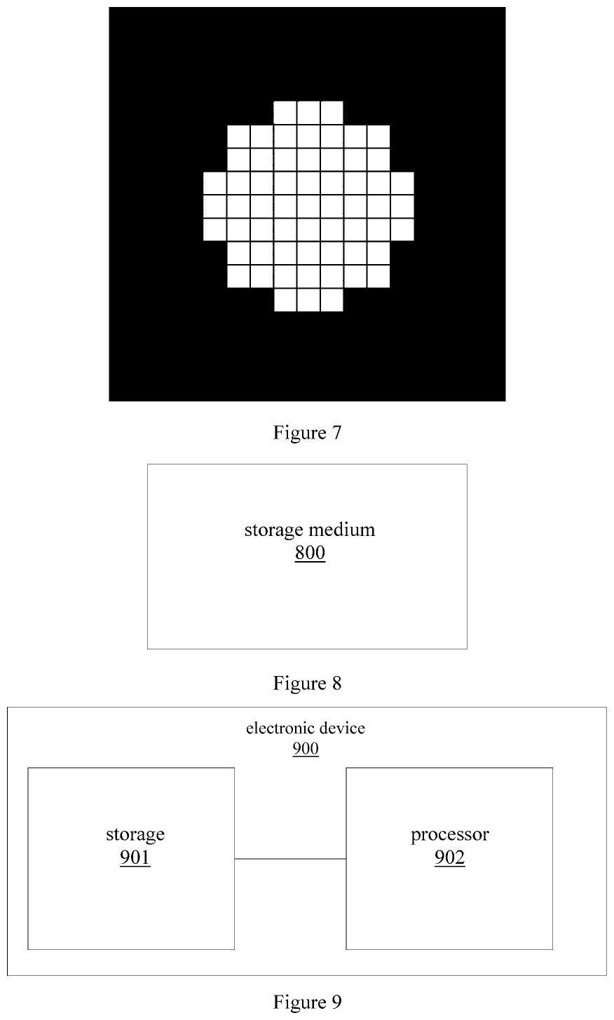

With existing display panels, preferable size and shape of a real point light source are shown in accompanying FIG. 7 (each grid represents a pixel, and positions of light sources are indicated by the white color), where a rectangle of 7 pixel*7 pixel is in the middle with a projection of three pixels in the middle of each side of the rectangle, which can achieve better imaging quality.

A preferable color of the light source is green, red or any color combination of a color between these two colors and another color; such colors may avoid interference of external light.

Display panels can be used not only as light sources to emit light, but also function to display images. Display panels include liquid-crystal displays (LCDs), active-matrix organic light-emitting diode (AMOLED) displays or micro light-emitting diode (micro-LED) displays; they each scan and drive a single pixel by a thin-film transformer (TFT) structure, and can achieve single driving for a pixel point, thereby achieving driving of the point light source and array-displaying, and allowing light to enter the light sensor after passing through gaps among pixel points.

The point light source array structure of this embodiment can be drawn using various ways of generation, for example, using graphic software, and then is displayed by a display panel; however, because accuracy requirement of a dot matrix is high, and because the number of points is relatively large, drawing efficiency of this method is low. Alternatively, the following manner may be used: before lighting up the pixel points, further included is a step of performing value-assignment for a matrix that has a same resolution as that of the display panel, wherein non-zero values are assigned to point light source regions, zero is assigned to the other regions, and the matrix that has assigned values serves as RGB information for generating a display image; the display image is transmitted to the display panel. After that, the following steps are performed: lighting up pixel points of multiple separate point light source regions of the display panel, wherein the point light source regions are arranged in an array and are spaced apart by nonluminous pixel points, and the point light source regions include multiple pixel points; and obtaining, through the light sensor, light of the pixel points that is totally reflected through the light transmissible cover plate. The display panel and the light sensor are placed under the light transmissible cover plate.

This embodiment takes the active-matrix organic light-emitting diode (AMOLED) display (1920×1080 pixels) as an example to illustrate generation of a point light source array structure. A programming language is used with this parameter to design a light source topology structure. The procedure of using the programming language to design the light source topology structure is in fact to assign values to a 1920*1080 matrix (a matrix that has 1920 rows, 1080 columns and all-zero data) by assigning a non-zero value (e.g., 255) to positions that need to be lit up and assigning a value of 0 otherwise, and then to use this matrix as RGB information of an 8-bit image (in the RGB information of an 8-bit image, a datum of 0 represents a black color, and a datum of 255 represents a fully saturated color) to generate a new image. A point light source array structure thus generated is shown in accompanying FIG. 5, wherein the white color represents the point light source region. The color of white is used only for graphic illustration, and can actually be green or red. Through the above-mentioned steps, a point light source array structure as needed may be generated with high efficiency, and thereby high-speed point light source driving may be achieved.

Although multiple pixel points are used to form one point light source and light up a fingerprint simultaneously, a single imaging cannot seamlessly scan the whole fingerprint. Using multiple point light source arrays that are complementary to one other may realize seamless scan, but the fingerprint image obtained by using each point light source array for illumination still has a fingerprint image portion lost. In order to obtain a complete fingerprint image, the present invention utilizes time-division multiplexing to realize full fingerprint coverage. Specifically, after a predetermined time interval, a same position offset is performed on all point light source regions; the step of lighting up pixel points and the step of obtaining light are repeated again until fingerprint images that satisfy a complete fingerprint splicing requirement, and then, after performing noise deduction and splicing on these fingerprint images, the complete fingerprint image can be obtained. Through the above-mentioned fingerprint image thus obtained, accuracy of subsequent screen thickness parameter calculation is guaranteed.

Please refer to FIG. 8. In this embodiment, an embodiment of a storage medium 800 is as follows:

The storage medium 800 of this embodiment may be a storage medium 800 that is disposed in an electronic device, and the electronic device may read the content of the storage medium 800 and achieve the effects of the present invention. Further, the storage medium 800 may be an independent storage medium 800, and by connecting the storage medium 800 and the electronic device, the electronic device is able to read the content in the storage medium 800 and to perform the method steps of the present invention.

The storage medium 800 includes but not limited to: RAM, ROM, a magnetic disk, a magnetic tape, an optical disk, flash memory, a USB disk, a portable hard disk, a memory card, a memory stick, network server storage, a network cloud server, etc.

The storage medium 800 stores a computer program. The computer program when executed by a processor performs steps of the method described in any item mentioned above.

Please refer to FIG. 9. In this embodiment, a specific embodiment of an electronic device 900 is as follows:

The electronic device 900 includes but not limited to: a personal computer, a server, a general purpose computer, a special purpose computer, a network device, an embedded device, a programmable device, a smart mobile terminal, a smart home appliance, a wearable smart device, a vehicle smart device, etc.

The electronic device 900 includes storage 901 and a processor 902. The storage 901 has a computer program stored therein. The computer program when executed by the processor 902 performs steps of the method described in any item mentioned above.

It needs to be made clear that although description with respect to each above-mentioned embodiment has been given in this specification, the patent protection scope of the present invention is not limited thereby. Therefore, based on the novel idea of the present invention, any alteration or modification made to the embodiments described in this specification, or equivalent structure or equivalent flow change that is made by using the content of the specification and the accompanying figures of the present invention, directly or indirectly applying the above-mentioned technical schemes in other related technical fields, are each included in the patent protection scope of the present invention.

1. A method for automatically searching for thickness parameters of a display screen, characterized by comprising steps of:
processing a fingerprint image to decide a circular dark region corresponding to any point light source, the circular dark region having a diameter of D; and calculating a screen thickness parameter based on a value of D.

2. The method for automatically searching for thickness parameters of a display screen of claim 1, characterized in that
the “processing a fingerprint image to decide a circular dark region corresponding to any point light source” further includes steps of:
deciding a position of a bright spot corresponding to a point light source in the fingerprint image, and performing gradual and outward scanning with the bright spot as a center of a circle, an edge where a scanned average grayscale value just meets a maximum value being regarded as the circumference of the circular dark region.

3. The method for automatically searching for thickness parameters of a display screen of claim 1, characterized in that
the “processing a fingerprint image to decide a circular dark region corresponding to any point light source” further includes a step of:
scanning the fingerprint image to encircle a region where grayscale values are below a predetermined threshold, an outmost edge of the region being regarded as the circumference of the circular dark region.

4. The method for automatically searching for thickness parameters of a display screen of claim 1, characterized in that
steps, before the “processing a fingerprint image”, are further included:
lighting up pixel points of multiple separate point light source regions of a display panel, wherein the point light source regions are arranged in an array and are spaced by nonluminous pixel points, the point light source regions including multiple pixel points;
obtaining, through a light sensor, light of a pixel point that is totally reflected through a light transmissible cover plate; the display panel and the light sensor being placed under the light transmissible cover plate.

5. The method for automatically searching for thickness parameters of a display screen of claim 4, characterized in that
the array arrangement is lateral arrangement and longitudinal arrangement, or the array arrangement is ring arrangement.

6. The method for automatically searching for thickness parameters of a display screen of claim 4, characterized in that:
an interval between two adjacent point light sources meets a condition that point light source total reflection images that are collected by the light sensor do not contact and do not repeat.

7. The method for automatically searching for thickness parameters of a display screen of claim 4, characterized in that:
the display panel is a liquid-crystal display, an active-matrix organic light-emitting diode display or a micro light-emitting diode display.

8. The method for automatically searching for thickness parameters of a display screen of claim 4, characterized in that:
the point light source region has a round-like shape.

9. A storage medium, characterized in that: the storage medium stores a computer program, wherein the computer program when executed by a processor performs the step(s) of the method of claim 1.

10. An electronic device, characterized by: comprising storage and a processor, wherein a computer program is stored in the storage, and the computer program when executed by the processor performs the step(s) of the method of claim 1.

11. A storage medium, characterized in that: the storage medium stores a computer program, wherein the computer program when executed by a processor performs the step(s) of the method of claim 2.

12. A storage medium, characterized in that: the storage medium stores a computer program, wherein the computer program when executed by a processor performs the step(s) of the method of claim 3.

13. A storage medium, characterized in that: the storage medium stores a computer program, wherein the computer program when executed by a processor performs the step(s) of the method of claim 4.

14. A storage medium, characterized in that: the storage medium stores a computer program, wherein the computer program when executed by a processor performs the step(s) of the method of claim 5.

15. A storage medium, characterized in that: the storage medium stores a computer program, wherein the computer program when executed by a processor performs the step(s) of the method of claim 6.

16. A storage medium, characterized in that: the storage medium stores a computer program, wherein the computer program when executed by a processor performs the step(s) of the method of claim 7.

17. A storage medium, characterized in that: the storage medium stores a computer program, wherein the computer program when executed by a processor performs the step(s) of the method of claim 8.

18. An electronic device, characterized by: comprising storage and a processor, wherein a computer program is stored in the storage, and the computer program when executed by the processor performs the step(s) of the method of claim 2.

19. An electronic device, characterized by: comprising storage and a processor, wherein a computer program is stored in the storage, and the computer program when executed by the processor performs the step(s) of the method of claim 3.

20. An electronic device, characterized by: comprising storage and a processor, wherein a computer program is stored in the storage, and the computer program when executed by the processor performs the step(s) of the method of claim 4.
